(19) United States
(12) Patent Application Publication
(10) Pub. No.: US 2007/0289635 A1
(43) Pub. Date: Dec. 20, 2007

(54) Secure wireless leak detection system

(76) Inventors: John D. Ghazarian, Henderson, NV (US); Ahmon Balaster, Boulder, CO (US); Tom Ruggieri, Santa Ana, CA (US)

Correspondence Address: JOHN D. GHAZARIAN, #1611, 2575 W. HORIZON RIDGE PKWY, HENDERSON, NV, 89052, US

(21) Appl. No.: 11/888,093

(22) Filed: Jul. 30, 2007

Related U.S. Application Data
(63) Continuation-in-part of application No. 11/158,953, filed on Jun. 22, 2005.

(51) Int. Cl. F16K 23/00

(52) U.S. Cl. 137/312

(57) ABSTRACT

Supervised wireless leak detection system, having a leak detection sensor unit, capable of transmitting a uniquely coded signal in response to a detected leak, a supervised wireless valve control transceiver unit having a receiver, capable of receiving said uniquely coded signal, and a transmitter for feeding the uniquely coded signal within the system, a valve shut-off mechanism in communication with said valve control transceiver unit said valve shut-off mechanism having a motor attached to a valve, said motor creating a rotation pulse used to close and open said valve, and a processor having an electronic circuitry containing sensor(s), detecting said motor rotation pulse count during a motorized valve closure or open process. Said processor functions in a setup process to memorize (learn) said motor rotation pulse count, required, to close and or to open the valve. Wherein said processor upon receipt of said uniquely coded signal in response to a detected leak, applies power to the motor to close the valve, the motor controlled to stop turning the valve in response to a processor received motor rotation pulse count number, substantially equal to a previously stored number needed to close or open said valve. A digital, voice, or SMS text message phone dialer is add to dispatch the detected leak signals, and notify monitoring personnel supervised system operation, end provide user access to turn on or off a valve(s) from a remote location(s).

### BACKGROUND OF INVENTION

In the past many different methods and devises have been used to detect liquid or gas leaks. Although some of those prior art teachings are found to be useful, in general most of prior art utilized different methods, to detect leak and shut off a solenoid or a motorized valve to stop detected leaks. The teachings found in prior arts are not able to provide adequate methods to secure the positive operation leak detection and prevention, in particularly teachings found in prior arts fail to provide fully supervised leak detection and damage control system, which ascertains system operation in accordance with the embodiment of the invention.

In addition prior art teachings found to be useful and contains some of the teachings found in present art, it is clear none of prior art teachings have or presents supervisory and positive operational improvement of the present art.

One such example U.S. Pat. No. 5,655,561 to Wendel et al. where teaches a method using a wireless leak detection, which provides a visible and audible alarm indication, including a buzzer and a user programmable digital voice circuit for identifying the area in which a flood occurs.

U.S. Pat. No. 6,310,555 to Stern, which describes a system for detection of presence to airborne water leak in microscopic amounts, using a flexible sensor pad with an outer and inner ring copper coils, and a electronic circuit designed to response to the presence of microscopic size water droplets, and alerting system with an audible and visible alarm.

U.S. Pat. No. 6,639,517 to Chapman et al. where illustrates a water leak detection mat, having one or more electrodes arranged in pattern around the upper surface of the base mat, such as the two wires of each pair are parallel to the other.

U.S. Pat. No. 6,662,821 B2 to Jacobsen et al. teaches a method for detecting leak and operating an existing valve shut off, in response to detected leak, using a motor attached to a valve via a coupler. The motor being control to stop turning the valve in response to the amount of current that generated to torque exceeds a predetermined current value, thereby closing the valve and terminating current supplied to the motor.

U.S. Pat. No. 6,880,806 B2 to Haikawa et al. wherein a valve gear includes a valve which controls flow rate of fluid and operation of which is determined according to rotation position of a valve element, using a actuator for providing a rotation force to a rotary valve shaft that changes the opening of the valve, and attaching/detaching means includes a locking element formed at its prescribed position which engaging element concave/convex portion, to prevent actuator from coming of the valve.

Perhaps the teaching found in U.S. Pat. No. 6,662,821 B2 to Jacobsen et al. is useful and represents a significant improvement in the aft, but it has it's limitation to provide secure valve shut-off mechanism, by mainly relying on measuring when the motor current exceeds a predetermined current value, to determine valve closure. One can presume if Jacobson et al. system was used on a rusted or frozen valve, the motor would not been able to turn the valve to its fully closed position. In this example; Jacobson at al. electronic circuitry will measure the limit of the predetermined current value; and therefore stop the current flow to the motor. The valve will thus remain open, which then fails to stop the leak and prevent property damage, or cause bodily injury or even human life loss, in such event where there is a gas leak. Also, if a phone dialer was used it would have provided misleading information to the monitoring station.

Another example prior art U.S. Pat. No. 5,908,980 to Hwang, et al. teaches a Gas pressure sensing method utilizing 1^{st} and second transmitter and receiver equipped in the controller unit, serving to transmit the controls signals from the controller unit to the driver unit and to receive data transmitted from the driver unit. The invention provides a method recognizing a gas leak by refereeing currently measured gas pressure with the reference pressure setting.

The use of pressure sensing method may not be reliable to detect a variety of slow leak conditions. Some leaks could be large enough to be easily detected, other leaks could be too small to create a detectable pressure drop, therefore when such system is in use, if and when a gas leak occurs during a period of time it builds up enough gas in a facility, which could create an undetected dangerous condition. Another disadvantage of the prior art is that, it cannot determine if a drop in gas pressure is created by a leak or by normal use of appliances. In addition, the prior art teaching does not utilize a supervisory valve shut off mechanism, valve motor failure to close the valve successfully, and accordingly initiate local alarm indication and signal an auto-dialer unit, to report the unsuccessful valve shut-off condition to a monitoring station.

U.S. Pat. No. 5,090,436 to Hoch, Jr., et al. teaches an automatic water supply shut-off system, utilizing a temperature sensitive switch disposed in the electrical circuit and is operative to normally close the electrical circuit above a predetermined temperature and open the electrical circuit at or below the predetermined temperature, whereby the shut-off valve moves to close position.

The teaching is useful, but the art is only is useful in applications, wherein the shut-off valve is responsive to temperature condition.

U.S. Pat. No. 6,489,895 to Apelman, discloses a fail safe leak detection and flood control prevention apparatus includes an induced current, trans-conductive Darlington amplifier and tuned-frequency standing water detector for controlling sensitivity of standing water detector for humidity, or dampness, level and for detecting a standing water leak, a 110 v latching relay driver circuitry is used in normally close position, which upon sensing a leak or dampness removes the electrical power for fail safe water cut-off. And initiating an outgoing telephone call to a predetermined telephone number for warning of the leak condition.

Even though the prior art is useful, but it does not utilize electronic circuitry to detect motor or gear turn cycle count to ascertain successful valve closure, and report successful or un-successful valve shut off condition through local audiovisual indication or through auto-dialer. Therefore the prior art is not as a reliable for use.

U.S. Pat. No. 6,719,489 to Colson, where discloses a selective suspension sewer drain closure apparatus for controlling flow of liquid, comprising a catch basin having a catch basin drain coupled with the sewer drain. Having a housing element positioned at predetermined height, allowing liquid to enter the housing, and a conduit coupled with the housing a second fluid tight manner, the conduit having an opening for allowing the liquid within the housing to flow to the sewer drain and position within the housing element above the predetermined height.

The prior art is useful in sewer applications where liquid flow is controlled by predetermined height of liquid in a housing. Such method cannot be useful in applications where a plurality of location water leaks may be detected by the use of sensors and activate remotely located valve control unit to close the valve when a leak condition occurs. The Colson art cannot be used in all-applicable condition.

U.S. Pat. No. 6,323,774 to Mitchell, illustrates a portable excess water usage control and alarm for use with an inlet water supply to prevent excessive usage of water due to leaks or human error, that includes a measuring means comprising a relatable impeller and shutoff valve connected to the inlet supply, and a processor that includes a program for setting threshold values of water volume anticipated by the particular household, which when exceeded, will set off an audio alarm or activate a telephone dialer to call a predetermined numbers. The system is programmed in volume increments of time, such as hours, days, or weeks to accommodate it's use.

Even though the prior art is useful, using rotating water pipe flow sensor, has it's limitations due to the fact that the system cannot know when some one is going to apply little or large amount of water use at any given time of the day, thus the day, timer set up in the art teaching is useful only in certain application, the use of teaching has the potential for false alarms. In addition the method does not provide a shut-off valve motor or gear counter to supervised successful closure of valve, and the auto-dialer found in the prior art, reports only when excess water flows through the pipe, without giving any confirmation of shut-off valve closure status. To the contrary, the auto dialer found in the present invention provides a successful or unsuccessful valve closure confirmation report to monitoring personnel.

U.S. Pat. No. 7,044,154 to Henderson, et al. wherein illustrates an apparatus for detecting and preventing fluid leaks, utilizing one or more fluid sensor connected to transmitter to communicate with a base unit. The base unit may receive signals from the transmitter when fluid sensor detects a fluid. The base unit may then communicate with a main shut off valve to restrict the flow of fluids into the property.

Useful prior art, but the teaching does not utilize any means of detecting un-successful valve closure, and accordingly generate audiovisual alarm signals when unsuccessful valve closure condition occurs. In addition, the base unit does not provide any means to notify through auto dialer the successful or unsuccessful valve closure condition to monitoring personnel. The use of such basic shut-off valve does not provide secure water leak damage prevention.

U.S. Pat. No. 6,123,093 to D'Antonio, et al. Teaches a method for regulating flow of fluid through a flow line, the system having a sensor for generating a signal in response to a parameter, a transmitter for transmitting a corresponding signal to a receiver, a receiver for receiving signal from the transmitter, an actuator containing a spring motor for operating pressure controlled regulator in response to signal received by the actuator for operating the valve.

The prior art is useful, but it does not provide lasting and secure method of shutting a valve mechanism, as spring (or gas pressure) mechanism is not long lasting reliable alternative to control a shut-off valve. D'Antonio, et al method of regulating a spring motor malfunction warning signals in response to the breakage of spring is an improvement, but such method is not reliable in long term use. D'Antonio method does not present the teaching found in the present invention, which provides a shut-off valve mechanism that uses electromagnetic or optical counter circuitry to read motor or motor gear rotation count, to determine successful or un-successful valve shut-off, in such conditions when a valve gets jammed, due to frost or rust. Also the prior art teaching does not provide a means of reporting the successful or un-successful valve shut-off information through local alarm, phone auto dialer or by wireless means.

U.S. Pat. No. 6,186,162 to Purvis, et al. discloses a leak detection and shut-off valve, utilizing a pair of adjacently disposed electrodes, a transmitter and a receiving means adapt to receive radio frequency signal from said transmitter, and upon its reception to actuate power to close a shut-off valve. The water shut-off valve is in the form of a ball valve. A timing logic using a cam switch causes current to flow to a valve driving motor as electric pulses. The cam being adapted to trip a switch the electric pulses allow control of current flow to the motor so that the ball valve stops moving upon completion of a ninety-degree rotation.

Even though Purvis, et al. teaching found to be useful, it does not provide a lasting and secure method of shutting a valve mechanism, as cam switches are made of mechanical contacts having a spring mechanism, which does not provide long lasting reliable means to control a shut-off valve. As known, dust, moisture, residue and switch spring mechanism has the potential to breakdown in long term usage. In particular if such switch mechanism was used in applications where daily closure and open of the valve is required, or routine system test was performed on a daily bases to supervise system proper operation, (Teaching found in the present art). The use of a mechanical switch, it does not provide a reliable shut-off valve mechanism, compared to teaching found in the present invention, which uses electromagnetic or optical counter circuitry to determine needed motor RPM or gear turn cycle, and stops the motor turning when required count is attained to fully close or open a valve. The present invention provides long lasting use of the system, capable of detecting successful or un-successful motor valve closure. Additionally Purvis, et al. teaching does not provide means of reporting the successful or un-successful motor valve shut-off condition information through a local audiovisual signals, or use of a phone auto dialer or by wireless means to report said conditions to a monitoring station. The use of camshaft switch for determining motor close or open position, limits the use of the art to be installed only within a pipes.

U.S. Pat. No. 5,967,171 to Dwyer, Jr. Discloses a shut-off system for use with a normally open manual actuated water valve, for automatically closing the valve upon sensing water. Utilizing at least one water sensor electrically or by RF transmission is connected to a motorized actuator mounted on the valve by the use of a J shape support bracket and coaxial valve stem rigidly connected the motor shaft by the use of a connector. The motorized actuator upon sensing water whereby said manual valve is actuated to its close position.

Even though prior art teaching of adapting a motorize valve to close an existing manual valve is useful, mounting the motor on a manual valve with the use of a J shape support bracket and rigidly attaching the valve stem to motor shaft by use of a connector, has reliability limitations. It requires a skilled person to perform such installation due to the fact valve stems may have different shapes, the valve stem could be Hex, rounded with spline, diagonal, oval, or uneven shape. In addition the use of J shape support bracket may not provide the needed support to securely mount the valve control motor housing on the pipe this could create motor shaft binding due to misalignment. Contrary to present art, which utilizes a self aligning universal coupler or a compliant U joint connection having elongated holes to allow for substantial misalignment of the motor shaft and the valve, to avoid possible binding. In addition Dwyers, Jr. teaching does not provide any means of detecting successful valve closure or valve open condition. Therefore use of unsupervised motor rotation may not put the valve in a complete close position, one can rely on Dwers, Jr. teaching, and only afterwards find out that damage has already been done to property due to system failure. The prior art method can only be used on a manual valve; it has no provision for use with other installed electrically actuated valves.

US Patent Application Publication 2003/0159732 A1 to Sanders teaches a building protection system which includes a switch, a transmitter, a receiver and a controllable shut-off valve disposed within the inlet line of utility. The switch is used to close or open the shut-off valve to stop the flow of utility. In one embodiment the switch is manually operated, in another embodiment, the switch is associated with a condition sensor. In still further embodiment the system includes an auto-dialer for automatically dialing a pre-determined list of phone numbers in repose to sensed condition, such as a message indicating that shut-off valve has been activated to stop the flow of the utility into the building.

The teachings found in Sanders are perhaps found to be useful, and it is an improvement to art, but use of low power RF wall mount or hand held transmitter has it's limitation, due to it is used to turn On/Off a motor valve from a short distance within a facility. Sanders teaching motor receiver does not contain a cellular, PSTN, satellite, by wireless means to receive commands to close or open the valve motor mechanism from remote locations.

Sanders teaching does not utilizes a motor gear rotation pulse counter, used to determine successful valve closure. Sanders teaching rather provides a processor timer circuitry to determine valve closure, which is know to be not accurate in long term use due to valve variation, environmental and temperature conditions, and motor/gear mechanism tolerance. The teaching may not be applicable to use with different valves styles, due to valve closure or open turn cycle that vary from one valve to another.

The auto dialer used in Sanders teaching operates only when condition arises requiring closing of master shut-off valve, and send a message that the shut-off valve has been activated. The teaching found in Sanders does not provide supervisory shot-off valve closure or valve open condition reporting through an auto-dialer, nor is it able to conduct periodic supervisory motor valve closure test and reporting, or use learning mode set up method for system memorize the number of motor or actuator shaft turn cycle required for complete close/open operation on any type of valve it is applied to. Further Sanders art does not teach the use of an auto-dialer that includes a PSTN/Cellular, or satellite receiver means capable of receiving command from distant locations to open or close the valve, and correspondingly receive confirmation that the valve has been successfully closed. In addition Sanders teaching, does not provide an RF computer interface transceiver unit which is capable of receiving the transmitted leak detection signals from leak sensors, and display the sensor unit ID on a computer screen within a site.

US Patent Application Publication 2002/0096213 A1 To Jacobsen et al. illustrates a method for closing an existing valve in response to a detected leak. Utilizing transmitter units including a detector capable of detecting fluids, and in response to the detector detecting the fluid, the transmitter unit may transmit a signal to a receiving unit. In response to said receiving signal, a processor may control a motor to operate the valve. The motor may be configured for attachment to the valve via a coupler.

The prior art of Jacobsen et al. presents an entirely different approach to open or close their valve as they use a stall motor that stalls when the valve is at the end of the rotation in either direction. Jacobsen et al. specification paragraph [0032] lines 5-12 states:

“Additionally, the microprocessor 210 may be configured to monitor the current being applied to the motor drive unit 200 to determine when the motor drive unit 200 has stalled and thereby, when the valve 110 has fully closed. Upon determining the motor drive unit 200 has stalled, the microprocessor 210 may be configured to issue a turnoff command to the motor drive unit 200.”

The present invention clearly defines over the prior art as the actuation mode to operate the valve is completely different in both structure and function. The “Jacobsen et al, invention disclose a microprocessor (210) that is configured to monitor the current being applied to the motor drive unit, by detecting the current, Jacobsen et al. teaching cannot measure directly or indirectly measuring the number of rotation of the motor.” If the motor is stalled it is not rotating and could not possibly measure the number of rotation(s) since it is stationary with no rotation at all.

The instant invention has many advantages over the prior art of Jacobsen et al. as it may be precisely controlled in rotation and the amount of torque required to open or close the valve. If the valve is frozen in a given position Jacobsen et al. have no way of indicating the malfunction as the motor is simply stalled indicating an open or closed orientation. The present invention is clearly an improvement as the control of the valve actuator is exacting as some valves leak if not rotated tightly enough and others may be over tightened to preclude opening if the seat has taken a set. Flexibility is simplified relative to a multitude of valve types as each one may be different in its requirements and the instant invention may accommodate different parameters with ease. Uniqueness and novelty is clearly found in the instant invention.

The present art discloses an adjustable bracket whereas Jacobsen et al. bracket (180) is apparently just attached to the motor (100) with no disclosed means at all for adjustment. The adjustment taught by Jacobson et al. is accomplished using a “threaded “J” bolt, a threaded “U” bolt, a plastic pipe clamp, etc.” (paragraph [0023] lines 5-6). Present art teaching adjustable bracket is truly variable in height from the pipe and in pipe diameter. This difference in structure is notable and should be taken in consideration as to its anticipation by the prior art.

Of greater importance is the use of a gear in present art teaching, which by itself defines over Jacobsen et al. particularly when the prior art teaching is completely silent regarding its use. Furthermore present art having a circuit including “an optical circuit, a magnetic circuit, and (or) electromechanical circuit to detect motor or gear turn cycles to provide supervisory valve closure” Jacobsen et al. have no gear or circuit with no reason to utilize any means to detect motor or gear turn cycles, again completely distinguishing in both structure and function.

Of additional importance is that the present invention has improved the art by the use of a coupler mechanism and a handle adaptor between the valve handle and the motor. It is well known in the art that it is possible to bind a valve if the attachment mechanism is misaligned. Jacobsen et al. have no provisions to circumvent this potential problem and this is particularly critical in their mode of operation where they rely only on a stalled motor for control. Since the prior art is silent in this matter the present art clearly defines as prior art certainly did not anticipate their combined use.

Accordingly Jacobsen et al. in U.S. Patent Application Publication No. 2002/0096213 A1 could not have found the claimed subject matter anticipatory.

In view of Sanders in U.S. Patent Application Publication No. 2003/0159732 A1.

A close look at Sanders teachings indicated in paragraph [0030] lines 9-14 the following: “When the receiver 14 receives the control signal from the transmitter, it generates a control signal of its own in relation to the received control signal. This second control signal is transmitted to the shut-off valve 16 to determine its on/off or open/close configuration.”

The present art on the other hand discloses a “valve closure detection sensor switch, located within said solenoid shut off valve”. It appears that Sanders takes and entirely different approach with his solenoid valve where he creates a “second control signal” from his receiver 14 and has no such sensor switch. The difference is so great in both structure and function that of Sanders teachings.

There can be no prima facie obviousness merely because the prior art can be modified to the claimed form without a suggestion of its desirability and Jacobsen et al. had no reason or did they indicate a desire to replace their manual valve with a solenoid valve. Further since Sanders did not teach a closure detection sensor switch he was no help in the matter.

There for, It is primarily objection of present invention, that uses a battery or A/C operated wireless water leak detection sensor, which contains a transmitter to transmit supervisory leak detection signal(s) to a motorize valve control unit to close the valve when leak is detected. The valve control unit of present invention utilizes a battery or A/C operated motorized valve shut-off mechanism which is incorporated with an electronic circuitry designed in a setup mode to detect motor or motor gear turn rotation pulse count, during a valve closure or open process. And the information then it is used to determine number of motor or motor gear turns required to close or open the valve. And accordingly the supervisory confirmation of a valve closure/open condition is been reported.

It is according to another objective of the present invention, that it utilizes a main control processor which is responsive to receive supervisory signal, and in response to the received signals generates power to turn the shut-of valve motor, and supervise the motor or motor gear rotation RPM during valve closure or opening process, and compare in processor database the actual received amount of motor or motor gear rotation RPM count, with processor pre-stored count information. If total of actual received count is a match with pre-stored count, the processor stop valve motor rotation, which then provides a supervisory successful valve closure confirmation to user.

In the event, if total number of motor or motor gear RPM count falls short or exceeds the pre-stored needed amount of motor or motor gear rotation count, the present invention's processor transmits an alarm signal indicating system failure in complete closing or opening the valve, by generating audiovisual alarm signals, or transmitting RF or PSTN, cellular, or satellite communication signals to monitoring personnel located at remote locations.

It is another objective of the present invention that the valve control unit is capable of receiving signals from a computer wireless interface unit for wirelessly or through a PSTN phone unit, or by wireless satellite Signals, to “Close” or “Open” the motor valve from remote locations, and report back to user with successful valve closure or open condition.

It is further objective of present invention, that provides re-liable optical, electromagnetic, or electromechanical counter circuitry to provide precise valve motor or motor gear rotation count, used for the processor to detect when the valve becomes in full open or close position, and stop the motor rotation when valve reach's fully close or open position.

It is another objective of present invention that eliminates the possibility of over running the motor under stress condition, such as when valve reach in fully close or open position, the motor stops rotating without creating pressure on motor gear assembly, valve assembly, and eliminates motor overheating condition. The present invention provides motorized valve shut-off mechanism which can be easily installed without limitation on all existing manual valves, or within a pipe and provides reliable, safe, long lasting motor, motor gear and valve mechanism performance.

It is further objective of present invention that provides a motorized valve actuator that is easily can be installed and aligned on an existing valve by the use of “Z” shape secure mounting bracket and a self aligning universal coupler or a U joint shaft utilization for providing alignment to avoid any possible binding in the event of a misalignment to avoid possible binding.

It is further objective of the present invention that provides maintenance and supervisory test method to periodically cycle the valve for open/closure, and report the condition of the valve and the system procedure result by audiovisual means, or report by means of PSTN or Cellular auto dialer or by wirelessly means.

It is further objective of present invention, utilizes a sensor unit, which powers up periodically and transmit a supervisory signals to the valve control unit, and or to auto-dialer or to a wireless PC interface unit. The supervisory method confirms that each wireless sensor unit is operational. If a supervisory signal is not received from a particular sensor unit, the system will initiate an alarm and report such failure through the audio/visual/voice announcement, and sends said alarm signals through the auto dialer or by wireless means to monitoring station.

It is the further objective of present invention that utilizes a supervised solenoid valve shut-off mechanism which contains a valve closure sensor detection switch, the switch is being connected to the valve control electronic circuitry which based on detected signal provides confirmation to successful valve closure or open status.

### SUMMARY OF INVENTION

A secure supervised wireless leak detection and prevention system, and methods used for the prevention of property damage and bodily injury or human life loss.

The system comprised of a wireless A/C or battery operated apparatus having liquid or gas detection sensor(s) incorporated with an RF transmitter, used for detecting liquid or gas leaks, and transmit (for 12 seconds) the detection signal(s) at preset time intervals to a valve shutoff control receiver or transceiver unit. The detection apparatus of the present invention is commonly installed at remote locations where liquid or gas pipes are present and where appliances are located.

An A/C or battery operated valve control RF receiver or a transceiver unit is used, to receive leak detection signal(s) from one or more RF wireless leak detection apparatus sensor units. And an onboard processor is used to control the operation of a liquid or gas pipe shutoff valve mechanism which may be plumbed into the pipeline, or may be installed on an existing shut-off valve without requiring any plumbing or pipe-fitting operation.

It is a primary objective of the present invention utilizing a valve control receiver or transceiver unit that operates on A/C or battery power. If a battery is used as the primary source of power, the battery life expectancy is 3 to 4 years, due to the low current consumption method used in the present invention. The low power consumption is achieved by setting the processor in sleep mode; and power up (Wake up) for approximately 0.5 second every 12 second to receive RF signals from a leak detection transmitter unit(s). This then provides coordinated timed RF communication between the wireless leak detection unit(s) and wireless valve control receiver unit, to minimize valve control receiver unit battery consumption. This provides a method for leak detection and prevention that can operate with A/C and or battery for extended periods of time and is completely wireless. If A/C power is available, battery operation may still be functional as backup in case of A/C power failure. The A/C power maintains a continuous charge of the battery when available.

When the valve control unit, receives an RF leak detection signal from a leak detection sensor unit, the valve control unit processor sends a pulse signal to a latching relay, which then activates a solenoid valve, having a valve closure sensing switch, which shuts the valve to stop the leak. If solenoid valve closes successfully, the valve closure sensing switch detects the valve closure and send a signal to valve control unit processor indicating successful valve shutoff. The valve control unit transmitter then sends this information to an auto-dialer phone or by other wireless means correspondingly to alert a monitoring station, The processor then enters into sleep mode to save battery, until a reset command is given to operate in stand by mode again.

The valve control unit used in the present invention is capable of indicating both leak detection, and successful valve closure or failure due to inoperative valve (stuck frozen valve), and valve control unit low battery condition, by means of generating visual or audible alarm signal(s) to the user, and transmit the leak detection information, and successful valve closure, or failed valve closure status and low battery conditions signals to a monitoring station via a phone auto-dialer, or by wireless means. The condition signals may contain digital data, DTMF or SMS text message or voice message(s) to alert monitoring personnel.

The present inventions monitoring station is equipped with a PC, which utilizes a phone line connection or an RF computer interface unit, which is able to receive leak sensor or shut-off valve unit condition signals, from remote location phone dialers or by wireless transceiver units. The computer interface unit upon receipt of the signals, it provide visual information and audible alarm in response to a detected leak signal, and system supervisory operation. It also provides a means to transmit commands from a remote location to reset, open or close the valve or program and control operational functions of a phone dialer or a wireless valve control transceiver unit.

In a preferred embodiment of the invention, the valve control receiver/transceiver unit is connected to a motor, which is securely mounted on a manual shutoff valve, or attached to a valve fitted pipe.

Wherein the valve control unit processor activates the motor to produce torque to turn the valve towards a close position in response to a detected leak signal. An electronic circuit is provided within the valve control unit, to monitor the shut-off valve motor or gear turn rotation cycles, to determine complete valve closure status. The motor is controlled by a processor to stop turning the valve in response to-detected number of motor or gear turn cycles which corresponds to processor pre-determined stored count required to complete valve closure; The predetermined stored count is determined through an automatic valve cycling set-up procedure, whereby the required turn count for any valve, close and open is counted by the processor and the count required to open or close the valve is stored into memory for subsequent operation comparison and verification. This then provides a positive indication of a successful valve shutoff process and generates audiovisual signals to notify the user of successful valve closure, or transmits the valve closure status through an auto dialer or by wireless means to monitoring personnel. The processor and receiver resume operation on reset command.

In the event the shutoff valve motor or actuator can not complete the needed preset cycle of valve turns to close the valve, due to a defective or corroded valve, the valve control unit produces an alarm signal and or transmits an RF signals containing information of a particular shutoff valve closure failure status to a monitoring station, through a phone dialer or through a wireless means.

To further assure the performance of the present invention, the present art is capable of periodically operating a manual valve shutoff and open test procedure. In such a test mode, if the valve control unit motor does not turn the necessary cycles to shutoff or open the valve, the valve control unit produces an alarm signal and or sends a valve mechanism failed signal to a monitoring station through a phone auto dialer device, or by wireless means.

The present invention provides a fully wireless A/C or battery operated/battery backup leak detection and damage prevention system, which is easily fitted inline on a pipe, or it could be installed with the use of a self aligning mounting bracket and valve adaptors, on an existing manual valve, or adjoining pipe. This provides a simple “do it yourself installation”. There is no need of running wires, plumbing, cutting, or fitting pipes, or worry about creating electrical hazard. There is no need for building inspector, or professional electrician and or a plumber. The valve control unit of the present invention may be used in indoor and outdoor applications.

### BRIEF DESCRIPTION OF THE DRAWINGS

FIG. 1. illustrates leak detection sensor/transmitting unit. And the view of receiving valve control unit, connected to a supervised motor valve mounted within a pipe.

FIG. 2. illustrates a perspective view of receiving valve control unit incorporated with a supervised motor mechanism circuitry, a battery, self-aligning valve handle adapter, and universal coupler mounted on an existing manual valve.

FIG. 2.B illustrates supervised motor circuitry, utilizing a U joint coupler mounted on existing manual valve.

FIG. 3. illustrates the view of universal coupler used with verity style valves.

FIG. 4. illustrates the view of receiving valve control unit connected to a supervised solenoid valve shut-off device, using valve-shut off detection sensor.

FIG. 5. illustrates the view of a phone auto dialer, or a wireless communication Apparatus.

FIG. 6 Is a block diagram of a supervised valve control unit, in accordance with the embodiment of the invention.

### DETAILED DESCRIPTION OF THE INVENTION

The principals of the invention are described by mainly in reference to a transmitter device unit capable of detecting the presence of any detected substance, and transmit this information wirelessly to one or more valve control units that can shut off the corresponding supply valve, report the detected leak and the success or failure of the supply shut off. The supervised leak detection and damage prevention system of the present invention is as illustrated in;

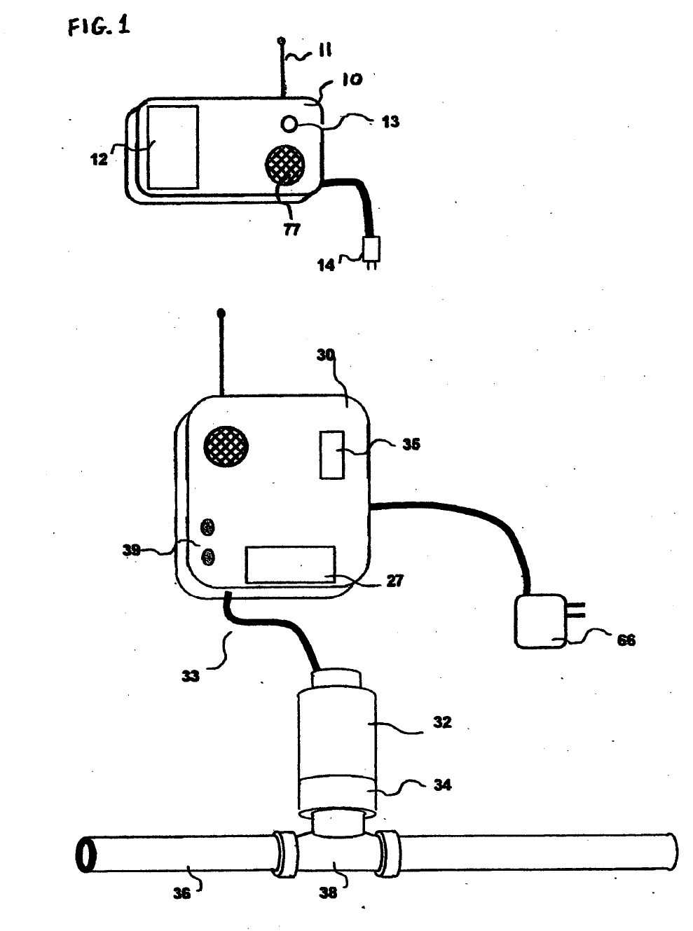

FIG. 1. A wireless leak detection unit 10 using a battery or A/C 12 or other power means, such as solar as power supply, equipped with a leak detection sensor 14 used to detect a variety of substances, such as water, gas, petroleum, etc. and a built-in transmitter is used to transmit the detected signals by use of an antenna 11. The leak detection unit is primarily is installed in buildings, homes, factories, in open field applications such as irrigation plants, petroleum plants and pipelines, etc. where there is high possibility for pipes and fittings to leak.

As illustrated, when a leak sensor 14 unit detects a leak, the transmitter 11 transmits a unique coded signal containing information of the leak detection unit 10, and an onboard LED 13 flashes to indicate unit leak detection and successful wireless transmission. A valve control unit 30 is in a housing. Utilizing A/C 66 or battery 27 or other power means such as solar as power supply, and having a motor 32 and gear 34 which is equipped with sensor means to detect motor 32 or gear 34 shaft rotation and provide corresponding electrical pulses to a processor 35 used in a setup process to send power to motor 32 to operate the attached valve 38 open and close, and count the motor 32 or gear 34 turn cycle pulses, and store in processor memory, the count required to close and open the valve that the motor 22 and gear 34 is attached to. The valve control unit 30 is connected to the supervised motorized valve 38 by a cable 33, the cable is used to provide power to the motor 32 and pass through motor rotation or gear count pulse detected signals to the valve control unit processor 35. The motor 32, pulse counter 34 and shut-off valve 38 are incorporated, and it is installed on a pipe line 36. The valve control unit processor upon receipt of detected leak signal, turns on the motor 32 to close the valve 38, and the processor 35 stops the motor 32 rotation based on received pre-determined required number of motor rotation cycle pulses or gear counter 34 signal. And the LED 39 turns Red indicating the valve 38 is closed. Further embodiment describes the details of use of the art.

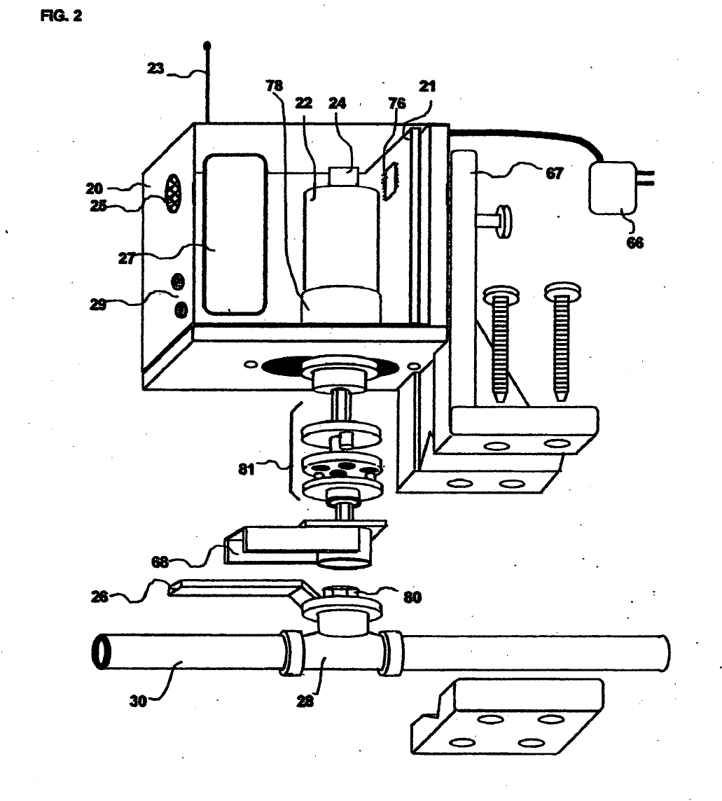

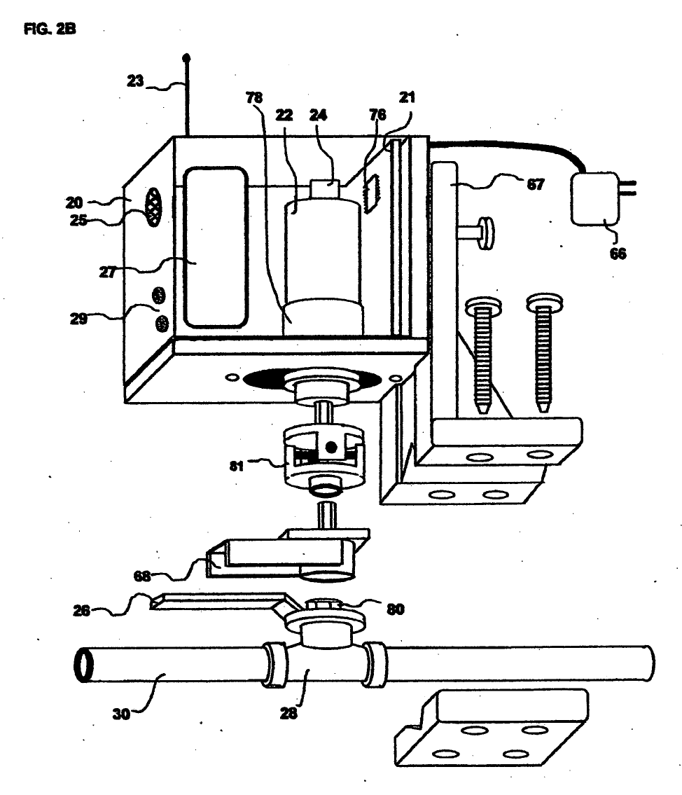

FIG. 2. Describes further embodiment and the details of a supervised valve shut-off system, wherein a control unit 20 housing, mounted on an adjustable bracket 67, used to mount the valve control unit securely on a pipe 36 or a manual valve, and the control unit is attached to the manual valve, by use of a flexible self-aligning valve handle adaptor 68. The valve control unit is powered by a battery 27 or by an A/C power supply 66. A motor 22 is incorporated to open and close the manual valve 26. The motor 22 contains an optical, magnetic, or an electromechanical circuit 24 to detect motor or gear turn cycles. A processor 76 is used in a setup process to memorize (learn) said motor 22 or gear 78 turn cycle pulse count required to close the valve that the motor 22 and gear 78 is attached to. And a transceiver 21 is incorporated to receive signals from a leak detection unit.

When the valve control unit 20 transceiver 21 receives a leak detection transmitted signal through the antenna 23, the transceiver 21 sends said received signal to the valve control unit processor 76. The processor 76 upon receipt of said signal, activates a relay or a FET transistor which turns the motor 22, the processor 76 during motor 22 turn cycle monitors motor generated pulse signals or gear counts, when the detected amount of pulses match the learned number found in processor 76 memory, the processor stops the motor 22 rotation, which completes the manual valve 28 closure. And red LED 29 blinks indicating the valve is shut.

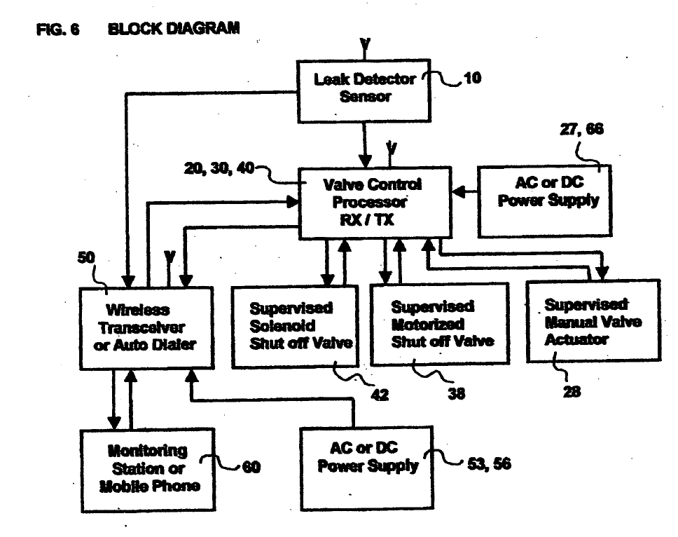

In the event the valve control unit processor 76 during valve 28 closure procedure, does not detect motor rotation pulse signals, or detects certain motor rotation pulse, which total less than that or more than of pre-determined needed number of pulses to completely close the valve 28, due to a corroded valve 28, a frozen valve 28, block valve handle 26 or a defective motor 22, or gear 78, the valve control unit beeper 25 generates an audible alarm and the transceiver 21 will transmit an alarm condition signal to a monitoring station (FIG. 6) 60. Or if the processor detects far more motor turn pulses than required number needed, due to a broken valve shaft, the valve control unit generates similar alarm conditions.

In addition the secure supervised wireless leak detection system of the present invention, provides a valve control unit processor which is programmed to periodically conduct a valve closure and open test/exercise procedure to ascertain and maintain system operation, and to notify the user if the valve shut-off motor fails to rotate the needed number of turns to completely close the valve or to open the valve.

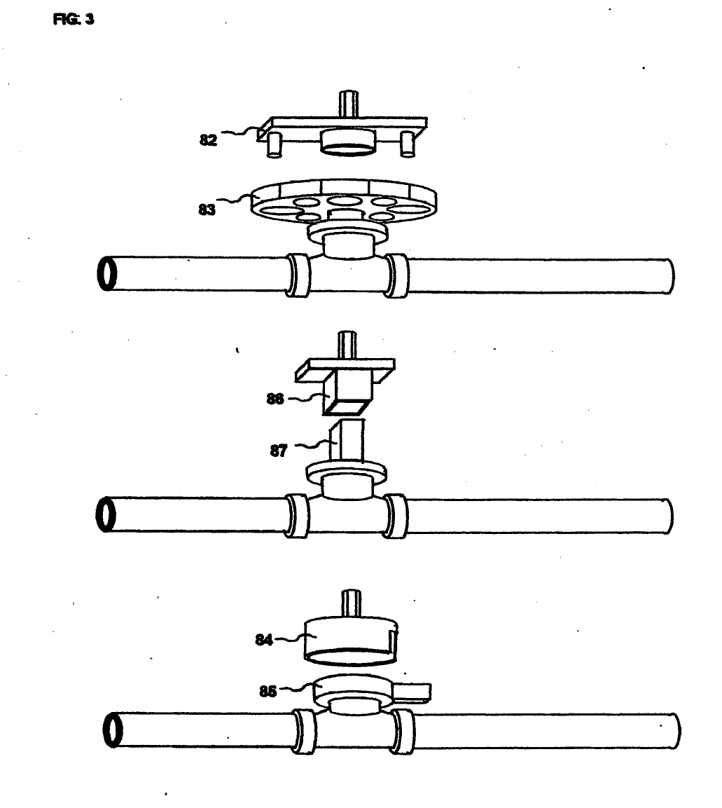

In addition, the valve handle adaptor 68 incorporates a centering and torque reaction feature whereby the center tube of the adaptor 68 fits snuggly over the existing manual valve shaft nut 80 (or handle hub 85 FIG. 3, in the case of a gas valve) to align and center the adaptor 68 (82, 84 and 86. FIG. 3 for a gate/globe valve and gas valve respectively) onto the manual handle 26 (83, 85 and 87 FIG. 3 gate/globe valve and gas valve) and to accommodate the torque reaction of motor gear 78 and adaptor 68 (82, 84, 86 FIG. 3) against the handle, FIG. 2 shows an example of a ball valve handle adaptor but the same centering, alignment, and torque reaction feature is used for gate valves, globe valves and gas valves as shown in FIG. 3.

To further aid in alignment or to avoid any possible binding in the event of a misalignment, a universal coupler mechanism 81 (FIG. 2) is used to transmit the torque between the motor shaft and the valve handle adaptor 68. The center connecting element of the coupler 81 may be made of metal, plastic, or a rubber material with elongated holes to allow for substantial misalignment of the motor shaft and the valve shaft as the torque is transmitted through the two pairs of pins. Or a U joint coupler 81 (FIG. 2B) mechanism is used to further overcome valve control motor mounting misalignment to avoid possible binding.

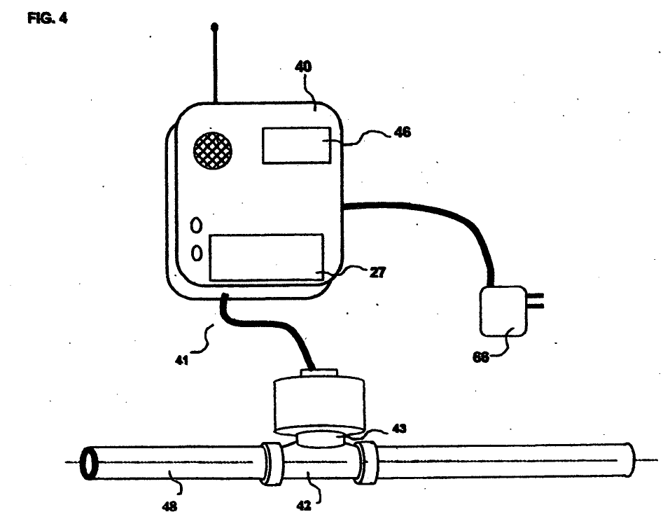

FIG. 4. Describes a fully supervised valve control unit 40, in a housing, and it is connected to a supervised solenoid shut-off valve assembly 42, installed within a pipe 48. to shut said valve when leak is detected. Said Valve control unit is connected to said solenoid valve by the use of a cable 41. to provide power and receive the valve closure supervisory signals. The supervised solenoid valve contains a valve closure detection sensor 43, which is used to detect solenoid valve 42 closures. The valve closure sensor 43 signal is received by the valve control unit processor 46 to confirm successful solenoid valve closure 42.

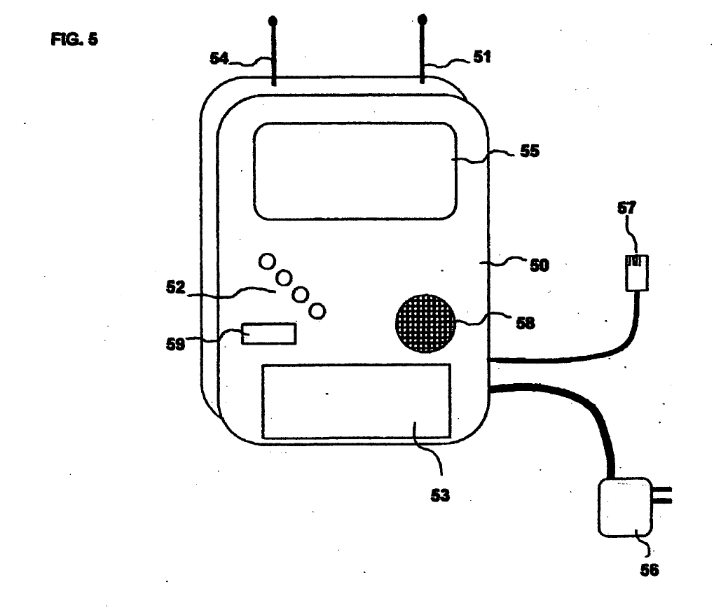

FIG. 5. Describes a Phone dialer 50, powered by an A/C source 56 or as preferred embodiment uses battery 53 or other power means such as solar as the power supply, especially if it's used in remote locations, where no A/C 56 power is available. The auto dialer unit 50 contains a processor 59, In order to save energy and provide long term battery life expectancy, the processor 59 powers on the auto dialer receiver circuitry at time interval duty cycle to conserve energy keeping the transceiver in power on mode for only a short period of time to receive a transmitted leak detection signal from a leak detection sensor unit, or receive command signals from a monitoring station. The processor 59 is pre-programmed with a unique code, to identify said auto dialer 50. A transceiver with antenna 51 is used to receive leak detection signals from leak detection unit(s), valve control units 20,30, monitoring computer. And the processor 59 is used to identify said leak detection unit and display the detected leak detection unit ID information on the LCD screen 55, produce a visual 52 and audible 58 alarm signal, and send both said leak detection unit ID information, valve controller ID information. and said auto dialer ID information through land phone line 57, cellular, satellite or by wireless means 54 to a monitoring station.

In a preferred embodiment of the invention, the leak detection units 10, 20, 30, 40, 50 used in the present invention contains a transceiver, and said valve control unit and or said phone auto dialer or wireless auto dialer 50 is capable at preset time interval to establish a supervisory communication to verify proper operation of the leak detection unit 10. In the event said valve control unit 20,30 or phone auto dialer unit 40 detects operational failure with a particular leak detection sensor 10, said valve control unit 20,30 or phone auto dialer unit 40 transmits a signal to the particular leak detection sensor unit 10, and leak detection unit beeper 77 produces a periodic alarm to signal personnel of a unit failure. In addition the phone auto dialer 50 notifies failed sensor 10 information to a monitoring station 60.

In a preferred embodiment, said phone auto dialer 50 can receive commands from a user located at a remote locations by use of a phone, PC, or by an RE communication, and subsequently transmit wirelessly said received commands to the valve control unit 20,30 to close or open said valve as requested.

In a preferred embodiment, said phone auto dialer 50 can receive commands from a user located at a remote locations by use of a phone, PC, or by an RF communication, and subsequently transmit wirelessly said received commands to the valve control unit 20,30 to close or open said valve as requested.

1. A supervised leak detection and damage prevention system, comprised of;
a remote supervised wireless leak detection unit, having; leak detection sensor circuitry, capable of transmitting a uniquely coded signal in response to a detected leak,
a supervised wireless valve control transceiver unit having a receiver, capable of receiving said uniquely coded signal, and a transmitter for feeding the uniquely coded signal within the system,
a valve shut-off mechanism in communication with said valve control transceiver unit said valve shut-off mechanism having a motor attached to a valve, said motor creating a rotation pulse used to close and open said valve, and
a processor having an electronic circuitry containing sensor(s), detecting said motor rotation pulse provided by said valve control transceiver, a supervised motor rotation pulse count producing a motorized valve closure or valve opening process, the valve fitted in a pipe line, said processor functions in a setup process to memorize (learn) said motor rotation pulse count, required, to close and or to open the valve that the motor is attached to, wherein said processor upon receipt of said uniquely coded signal in response to a detected leak, applies power to the motor generating torque to close the valve, the motor controlled to stop turning the valve in response to a processor received motor rotation pulse count number, substantially equal to a previously stored number needed to close or open said valve.

2. The supervised leak detection and damage prevention system, as recited in claim 1 wherein said valve shut-off mechanism further comprises,
a housing,
an adjustable bracket, mounted to said housing used to mount the valve shut-off mechanism securely on a pipe,
a motor contained within the housing having a gear therein attached to a manual valve, said motor having a circuit selected from the group consisting of an optical circuit, a magnetic circuit, and an electromechanical circuit to detect motor or gear turn cycles to provide supervisory valve closure operation, said processor is programmed, in a setup process to memorize (learn) a motor or gear turn cycle pulse count required to close the manual valve that the motor is attached to,
said valve control transceiver receives a signals from the leak detection unit wherein the valve control transceiver unit upon receipt of the leak detection signal, sends said signal to the processor, the processor circuitry in response to said received signal turns the motor to generate torque to close the valve, the motor stops turning the valve in response to processor received number of motor or gear turn cycle pulse counts, equal to predetermined turns to close or open the valve, and
a handle adaptor attached to said motor shaft used to open and close the manual valve.

3. The supervised leak detection and damage prevention system as recited in claim 1 further comprising,
said processor is programmed to generate an audio and visual alarm, and
said valve control transceiver is programmed to transmits an alarm condition signal to a monitoring station through a phone auto dialer or by wireless means.

4. The supervised leak detection and damage prevention system as recited in claim 1 wherein said processor is programmed to periodically conduct a valve “closure” and “open” test/exercise procedure to ascertain and maintain system operation, and provide said test/exercise procedure condition status, by means of a local audiovisual signal, and transmitting said audiovisual signal through an auto dialer or wireless means to monitoring station personnel.

5. The supervised leak detection and damage prevention system as recited in claim 2 further comprising a universal coupler mechanism selected from the group consisting of a universal coupler and a U joint coupler, utilized for alignment of said motor shaft to said valve to avoid any possible binding in case of a misalignment,
said valve having a handle adaptor,
said universal coupler mechanism transmits torque between the motor shaft and the valve handle adaptor, a center connection element within the universal coupler having elongated holes and two pairs of pins allowing substantial misalignment of the motor shaft and the valve handle adaptor, as torque is transmitted through the two pairs of pins, and
said U joint coupler mechanism is used to further overcome valve control motor mounting misalignment avoiding binding.

6. A supervised leak detection and damage prevention system, comprised of,
a remote supervised wireless leak detection unit, having; leak detection sensor circuitry, capable of transmitting a uniquely coded signal in response to a detected leak,
a supervised wireless valve control transceiver unit having a receiver, capable of receiving said uniquely coded signal, and said wireless valve control transceiver having a transmitter for feeding the uniquely coded signal within the system,
a valve shut-off mechanism in communication with said valve control transceiver unit said valve shut-off mechanism having a supervised solenoid shut off valve assembly installed within a pipe,
a processor generating energy to close said supervised solenoid shut off valve assembly, in response to a received uniquely coded leak detection signal from the leak detection unit sensor, and
a valve closure detection sensor switch, located within said solenoid shut off valve assembly, for detecting a solenoid valve close position or solenoid valve open position, said valve closure detection sensor switch feeds a detected solenoid valve close position or solenoid valve open position signal, to said processor, in response to said detected signal, which notifies a user successful solenoid valve close position or solenoid valve open position, by means of audiovisual signals, or by use of an auto-dialer or by wireless means to monitoring personnel located at a remote location.

7. A supervised leak detection and damage prevention system which comprises,
a supervisory phone auto dialer having a phone auto dialer processor pre-programmed with a unique code, to identify said supervisory phone auto dialer,
said supervisory phone auto dialer having a phone auto dialer transceiver with antenna to receive a leak detection signal from a leak detection unit, said transceiver sends said leak detection signal for display on a remote screen including leak detection unit ID information, and
said phone auto dialer produces a visual and an audible alarm signal in response to said received leak detection signal and sends to a monitoring station leak detection unit ID information, auto dialer ID information, and supervisory valve closure or opening status, through a land phone line, cellular, satellite or wireless means, said phone auto dialer energized by power means including A/C and battery.

8. The supervised leak detection and damage prevention system as recited in claim 7, wherein said phone auto dialer, at a preset time interval-establishes a supervisory communication to verify proper operation of the leak detection unit and phone auto dialer, said phone auto dialer transmits a signal to a particular leak detection unit, and produces a audio and a visual alarm to notify user personnel the presence of a failed leak detector unit, said phone auto dialer displays failed leak detection unit ID information and transmits a signal containing information to said particular failed leak detection unit and a particular phone auto dialer information to a monitoring station.

9. The supervised leak detection and damage prevention system as recited in claim 1 or 8, wherein said phone auto dialer and a wireless PC communication means, receives commands from a user phone or a PC located at a remote location and subsequently transmits wirelessly received commands to said valve shut-off mechanism to close or open said valve or perform a supervisory test function as requested, and transmit said valve shut-off mechanism successful valve closure or valve opening process status to said user phone or PC.

10. The supervised leak detection and damage prevention system, as recited in claim 1 or 8 wherein said phone auto dialer, a wireless cellular dialer or a satellite or wireless means, transmit supervisory leak detection and valve closure and open detection confirmation, or periodic supervisory test procedure, information by means of a digital data, a prerecorded voice message, or by a text message to a monitoring station.

11. The supervised leak detection and damage prevention system as recited in claim 1 wherein said leak detection unit and said valve shut-off mechanism is powered by A/C, Battery or other power means, for operation.
